(19) United States
(12) Patent Application Publication
(10) Pub. No.: US 2004/0139031 A1
(43) Pub. Date: Jul. 15, 2004

(54) Systems and methods for providing an interactive trading application

(76) Inventors: Lee Amaitis, London (GB); Howard W. Lutnick, New york, NY (US)

Correspondence Address: FISH & NEAVE, 1251 AVENUE OF THE AMERICAS, 50TH FLOOR, NEW YORK, NY, 10020-1105, US

(21) Appl. No.: 10/446,572

(22) Filed: May 27, 2003

Related U.S. Application Data
(60) Provisional application No. 60/454,194, filed on Mar. 10, 2003.
(60) Provisional application No. 60/437,157, filed on Dec. 27, 2002.

(51) Int. Cl. H04K 1/00

(52) U.S. Cl. 705/80

(57) ABSTRACT

An interactive trading application is provided that allows users to create and trade indices. When the user selects securities to add to a new index, the interactive trading application may provide guidance to the user to ensure that the created index meets criteria, such as regulatory criteria. The user may be able to trade, for example, a binary option on the created index. Head-to-head trading may be performed with other users of the interactive trading application. Each user selects securities upon which an option trade is placed against the securities selected by the other users for an option period. The criteria for success for an option trade may be adjusted at the time the trade is placed to account for initial market factors such as volatility and during the option period to account for intervening significant events such as payment of dividends, events of corporate significance, and global market events.

This claims the benefit of copending U.S. Provisional Patent Applications No. 60/454,194, filed Mar. 10, 2003, and 60/437,157, filed Dec. 27, 2002, which are hereby incorporated by reference herein in their entireties.

### BACKGROUND OF THE INVENTION

The present invention relates to systems and methods for providing an interactive trading application, and more particularly, the present invention relates to systems and methods for creating and trading an index, performing head-to-head trading, and adjusting the criterion for success of a trade according to certain initial market factors and intervening significant events.

There are numerous reasons why an investor or trader would want to create and trade an index. For example, because an index comprises multiple tradable securities, an index is a diversified investment and may have lower transaction costs associated therewith than the transaction costs associated with trading all of the component tradable securities separately.

The trading of indices in countries are generally regulated. The composition of the index may determine which regulatory body or bodies oversee the transactions. For example, the trading of futures on a narrow market index in the United States are subject to joint regulation by the Commodity Futures Trading Commission (CFTC) and the Securities and Exchange Commission (SEC). However, if an index satisfies the criteria for a broad market index, then the trading of futures on that index is only subject to regulation by the CFTC. Therefore, it would be desirable to facilitate the creation of an index that satisfies certain criteria. It would also be desirable to facilitate the trading of the created index.

There are also numerous reasons why an investor or trader would want to perform head-to-head trading with other investors or traders. For example, head-to-head trading would allow two counterparties to exchange a specific trading risk. Therefore, it would be desirable to perform head-to-head trading.

There are also numerous reasons why an investor or trader would want the criterion for success to be adjusted for an option order according to certain initial market factors or intervening significant events. For example, if a company announces and issues a large dividend, this would generally decrease the company's share price which could adversely affect the payout of an option order, while the quality of the company underlying the option has not changed. Therefore, it would be desirable to adjust the criteria for success in an option order according to certain initial factors or intervening significant events.

### SUMMARY OF THE INVENTION

It is therefore an object of the present invention to facilitate the creation of an index that satisfies certain criteria. It is also an object of the present invention to facilitate the trading of the created index. It is another object of the present invention to perform head-to-head trading. It is another object of the present invention to adjust the criteria for success in an option order according to certain initial market factors or corporate events.

These and other objects of the invention are accomplished in accordance with the principles of the present invention by providing an interactive trading application.

The interactive trading application may be implemented on any suitable hardware, software, or combination thereof. For example, the interactive trading application may be implemented on one or more computers that may be connected by one or more communications links.

The interactive trading application may provide the user with interactive screens containing menus and selectable options that allow the user to navigate through the interactive trading application, participate in creating and trading an index, perform head-to-head trading, and adjust the criteria for success in an option order according to certain initial market factors or corporate events. The user may use a keyboard, mouse, trackball, touch pad, touch sensitive screen, or other suitable input or pointing device to navigate the various menus and selectable options.

The user may begin an application session by accessing the interactive trading application with, for example, a user computer. The user may access the interactive trading application by browsing to an Internet web site or a site on a private network, by running a local program, or by any other suitable method. After logging on, the user may be presented with a screen that allows the user to view previously created indices. The screen may include a navigation bar that facilitates navigation between screens of the interactive trading application.

The interactive trading application may allow the user to edit a previously created index or to create a new index that satisfies certain criteria. For example, the criteria could be the criteria for a broad market index or any other suitable criteria. The user may add component securities to the index by entering in the name of the security or by selecting the security from a list of available securities. The user may filter and sort through the list of available securities to find desired securities. For example, the user may filter the list by industry sector or market capitalization. The user may also remove securities from the index by selecting a security and pressing a button such as a remove button.

The interactive trading application may allow the user to select the level of guidance provided while the user is creating and editing an index. For example, the user may select whether to be provided with a beginner, intermediate, expert, or custom level of guidance. The beginner level may provide the user with the most guidance, while the expert level may provide the user with the least guidance.

When the user selects custom for the level of guidance, the user may be provided with individual guidance features that may be selected. For example, the individual guidance features that may be selected by the user may include: hide securities that do not meet the criteria, display securities that meet the criteria and the securities that do not meet the criteria in a different manner, do not provide suggestions or guidance, always provide guidance after a security is added, prevent user from adding a security that does not meet the criteria, and any other suitable guidance features.

The interactive trading application may provide a warning to a user when some of the criteria are met by only a small amount. In addition, the interactive trading application may require a margin of safety for some of the criteria. Therefore, small fluctuations in the share price of the component securities will not cause the created index to fail to meet the criteria for the desired type of index.

When a user has created an index that satisfies the criteria, the user may enter a name for the index and save the index with the interactive trading application.

The interactive trading application may allow the user to request that the system provider obtain certification of the created index from a regulatory agency or agencies. The interactive trading application may automatically send the created index to the regulatory agency or agencies for approval, or alternatively, the interactive trading application may require the system provider to manually submit the created index to the regulatory agency or agencies. Electronic submission of an index can take place via electronic mail, via a form on the regulatory agency or agencies website(s), via a direct connection to a regulatory agency or agencies server(s), using a separate dedicated index submission application, or by any other suitable means. An index may also be submitted to the regulatory agency or agencies via postal service.

The interactive trading application also allows the user to trade a created index. In the case of a broad market index, if the CFTC approves of the created index, then futures on the created index, and options on those futures (including but not limited to binary options), may be traded on a fully margined futures exchange basis. Depending on the approval that is required and the regulatory agency or agencies, a user may be able to create and trade an index immediately or with some time delay.

In another embodiment, it may be possible to obtain approval from a regulatory agency or agencies of the interactive trading application. If the interactive trading application is approved, then any indices created using the interactive trading application would meet the criteria. This advance approval of the interactive trading application may no longer require certain advance approval requirements of each index. Therefore, this may decrease the time it would normally take to obtain approval to trade the index.

The interactive trading application may also allow a user to create or join a head-to-head trading session. When the user creates a new head-to-head trading, the interactive trading application may prompt the user to define the parameters of the head-to-head trading session, including, for example, the criterion for success of trades that are to be placed. When the user wishes joins an existing head-to-head trading session, the user may select a desired session from a list of available sessions. The available trading sessions may be displayed with additional information such as information relating to the type, settings, number of users and other notes for each available head-to-head trading session.

In a head-to-head trading session, each user may select one or more securities, including an index, to trade against each other user. The prevailing user in a head-to-head trade is the first user whose security or securities meet the criterion for success of the trade.

The head-to-head trading session interface may include a partitioned display screen in which each user can see the securities selected by the other users. The interface may also include a chat window that allows the users to communicate to each other in order to facilitate creating and placing the trade.

In another embodiment of head-to-head trading, the head-to-head trading session may allow cooperating users to each define an index to trade with against another group of cooperating users. The indices for each group of cooperating users can be combined to form a virtual index on which cooperating users can place a trade.

In another embodiment of head-to-head trading, the head-to-head trading session may be presented in the form of one or more themes such as a sports theme. For example, the head-to-head trading session may allow users to select a “basketball team” of securities to place head-to-head trades. Another suitable sports theme would be a horse racing theme. For example, the head-to-head trading session may allow a user to enter a horse race, where each participating user selects a single horse (any available security) on which to place an order. The prevailing horse would be the security that meets the criterion for success first.

In another embodiment of head-to-head trading, instead of defining groups of securities, users may define groups of sports teams upon which to place a trade. Alternatively, users may also define groups of sports players upon which to place a trade. The criterion for success may be based on the performance of the sports teams and players. The head-to-head trading of sports teams and players may be regulated by a state gaming commission or other suitable regulatory body or bodies.

The interactive trading application may also allow for the adjustment of the criterion for success in an option trade according to initial market factors or intervening significant events. The trade may be a head-to-head trade or any other suitable trade.

When the user is creating an option order, the interactive trading application may allow the user to adjust the criterion for success to account for a greater or lesser likelihood of success based on initial market factors, such as volatility.

Intervening significant events that occur during the option period may also be a factor for adjusting the criterion for success of a trade. An intervening significant event may, for example, be an event of corporate significance. Such events of corporate significance may include: an increase of dividend, the buyback of stock, conception of a new company, divestitures, acquisitions, and any other suitable events. Other intervening significant events may include the release of industry relevant data and global market events such as war, political turmoil, terrorism, outbreak of disease, natural disasters, and any other suitable global market events. These intervening significant events may be quantified and factored out of the price of the securities in order to provide an objective comparison of the companies underlying the securities.

In another embodiment, the required order amounts for an option trade can be adjusted instead of the criterion for success. The above-mentioned initial factors and intervening significant events that occur during the option period may affect the payment amount to the prevailing trader. The prevailing trader may be paid more or less than the sum of the order amounts if the prevailing trade had a smaller likelihood of prevailing or a larger likelihood of prevailing, respectively. Similarly, the losing trading may have to pay more or get refunded for a portion of the order amount if the prevailing trade has a smaller likelihood of prevailing or a larger likelihood of prevailing, respectively.

The interactive trading application may also present the user with a trading history window that includes information relevant to each order placed by the user and its current status.

### BRIEF DESCRIPTION OF THE DRAWINGS

Further features of the invention, its nature, and various advantages will be apparent from the following detailed description of the preferred embodiments, taken in conjunction with the accompanying drawings, in which like reference characters refer to like parts throughout, and in which:

FIG. 1 shows an illustrative system in accordance with the present invention, upon which the interactive trading application may be implemented.

FIG. 2 shows an illustrative screen in accordance with the present invention, which allows a user to view previously created indices.

FIG. 3 shows an illustrative screen in accordance with the present invention, which allows a user to create or edit an index that meets certain criteria.

FIG. 4 shows an illustrative screen in accordance with the present invention, which allows a user to place a trade on a previously created index.

FIG. 5 shows an illustrative flow diagram of illustrative steps involved in creating and trading an index in accordance with the present invention.

FIG. 6 shows an illustrative screen in accordance with the present invention, which allows a user to join or create a head-to-head trading session.

FIG. 7 shows an illustrative screen in accordance with the present invention, which allows a user to place an option order in a head-to-head trading session.

FIG. 8 shows an illustrative flow diagram of illustrative steps involved in performing head-to-head trading in accordance with the present invention.

FIG. 9 shows an illustration of a flow diagram of illustrative steps involved in adjusting the criterion for success in a trade in accordance with the present invention.

### DETAILED DESCRIPTION OF THE PREFERRED EMBODIMENTS

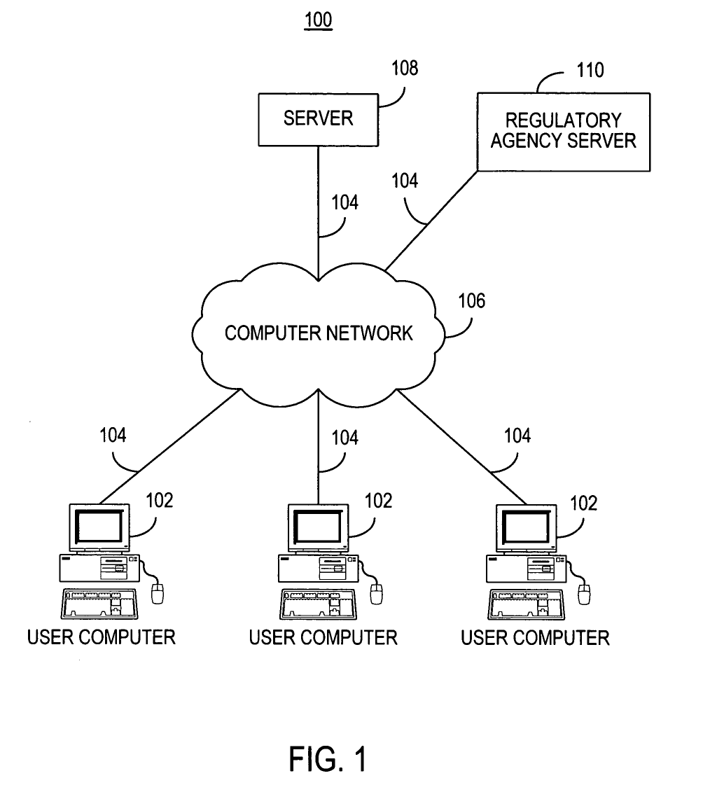

FIG. 1 shows an illustrative system upon which an interactive trading application can be implemented in accordance with the present invention. As illustrated, system 100 may include one or more user computers 102. The user computers are connected via one or more communication links 104 to a computer network 106 that is linked via communication link 104 to server 108 and regulatory agency server 110.

In system 100, server 108 and regulatory agency server 110 may be any suitable server, processor, computer, or data processing device, or combination of the same.

Computer network 106 may be any suitable computer network including the Internet, an intranet, a wide-area network (WAN), a local area network (LAN), a wireless network, a digital subscriber line (DSL) network, a frame relay network, an asynchronous transfer mode (ATM) network, a virtual private network (VPN), or any combination of any of the same.

Communication links 104 may be any communications links suitable for communicating data between user computers 102 and server 108, between user computer 102 and regulatory agency server 110, and between server 108 and regulatory agency server 110, such as network links, dial-up links, wireless links, hard-wired links, etc.

User computers 102 may be personal computers, laptop computers, mainframe computers, dumb terminals, Internet browsers, Personal Digital Assistants (PDAs), two-way pagers, wireless terminals, portable telephones, etc., or any combination of the same.

The interactive trading application may provide the user with interactive screens containing menus and selectable options that allow the user to navigate through the interactive trading application, participate in creating and trading an index, perform head-to-head trading, and adjust the criterion for success of a trade. The user may use a keyboard, mouse, trackball, touch pad, touch sensitive screen, or other suitable input or pointing device to navigate the various menus and selectable options.

The user may initiate an application session by accessing the interactive trading application with user computer 102. The user may access the interactive trading application by browsing to an Internet web site or a site on a private network, by running a local program, or by any other suitable method.

When the user initiates an application session by entering into the interactive trading application, the interactive trading application may prompt the user to log on with a username and password. After logging on, the user will preferably be presented with a screen such as screen 200.

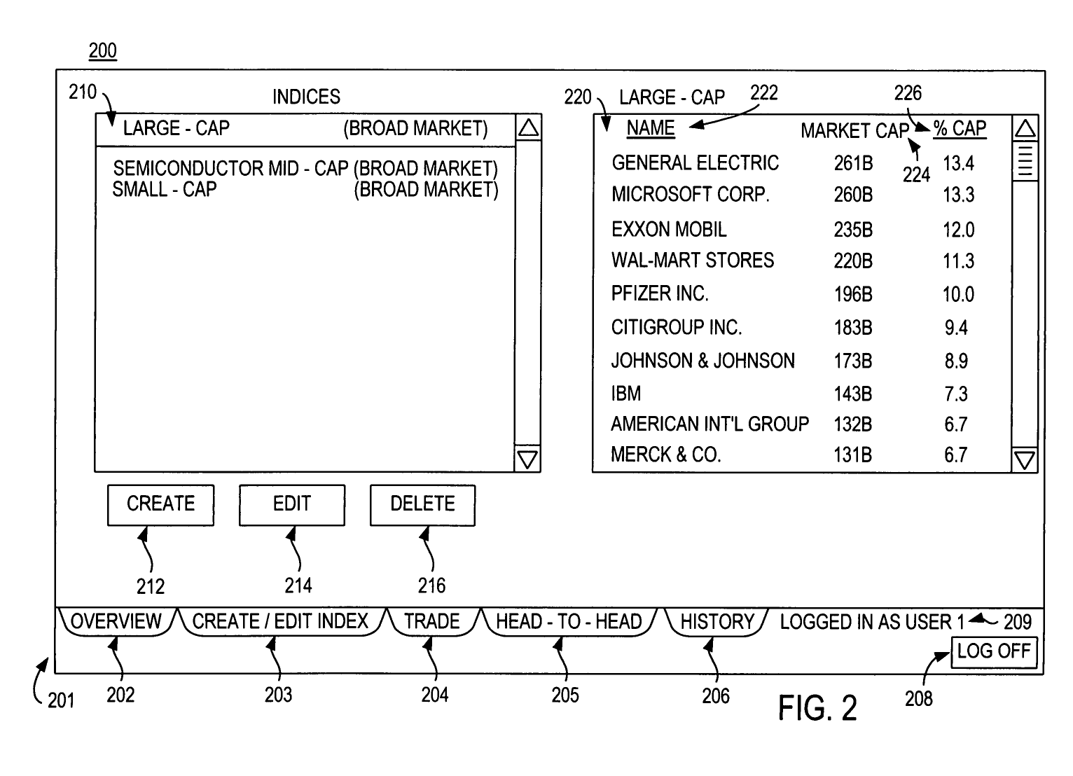

FIG. 2 shows an illustrative screen in accordance with the present invention, which allows the user to view indices previously created by the user. At the bottom of screen 200 and other screens of the interactive trading application is a navigation/status bar 201. Navigation/status bar 201 includes several tabs to facilitate navigation between screens of the interactive trading application. For example, screen 200 may be accessed from any screen by selecting overview tab 202. Navigation/status bar 201 may also include create/edit index tab 203, trade tab 204, head-to-head tab 205, and history tab 206. When a user navigates between screens during an application session via tabs 202-206, the information previously displayed or the options previously selected in the previously visited screen will preferably be preserved.

Navigation/status bar 201 may also include a message 209 indicating the user that is currently logged into the system or any other suitable information. Navigation/status bar 201 may also include log off button 208. When a user presses log off button 20.8, the interactive trading application will log the current user off and terminate the application session.

Screen 200 also includes index window 210, securities window 220 and associated create button 212, edit button 214, and delete button 216. Index window 210 shows a list of indices that have been created by the user as well as the type of index for each index. The indices may be presented in alphabetical order, ordered by date of creation, or by any other suitable approach. An index is composed of at least two securities. Securities window 220 shows the individual securities that make up the index highlighted in index window 210. Securities window 220, as shown, includes for each component security, its market capitalization and the percentage of the total market capitalization of the index. Securities window 220 may also include for each component security, current price, market capitalization, bid price, ask price, market price, trading volume, 52 week high price and 52 week low price, various ratios (e.g. price-to-earnings and price-to-book), dividend yield, or any other suitable information. Preferably, the name of the selected index will be displayed above securities window 220. By selecting name header 222, market capitalization header 224, or percentage header 226, the listed securities can be sorted by name, by market capitalization, or by percentage, respectively. By selecting header 222, 224, or 226 again, the order in which the securities are displayed may be reversed.

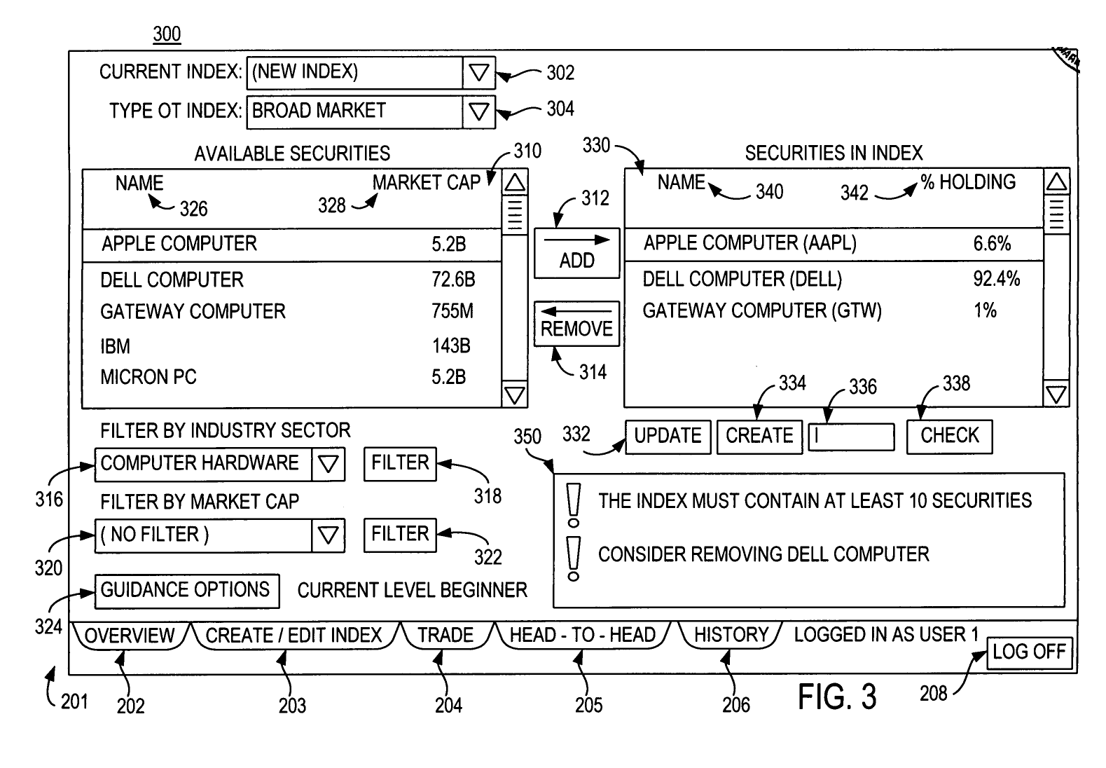

Create button 212 allows a user to create a new index. When the user selects create button 212, the interactive trading application may display a screen such as screen 300 of FIG. 3. Alternatively, the user may access screen 300 of FIG. 3 by selecting create/edit index tab 203. Screen 300 of FIG. 3 may also allow a user to edit a selected index. Therefore, the interactive trading application may display screen 300 of FIG. 3 when the user selects edit button 214. Delete button 216 allows a user to delete a selected index from their view.

The user interface of the interactive trading application as shown in FIGS. 2-4, 6, and 7, uses commonly used application objects such as buttons, drop down menus, and checkboxes. It will be understood that these objects are only illustrative, and other objects can be used by those skilled in the art without departing from the scope and spirit of the present invention. For example, buttons 212, 214, and 216 in FIG. 2 can be replaced with a single drop down menu with four options.

FIG. 3, as described above, shows an illustrative screen 300 in accordance with the present invention that allows a user to create or edit an index that meets certain criteria.

For purposes of illustration and not limitation, the present invention will be described in connection with creating a broad market index. As discussed earlier, the CFTC has exclusive jurisdiction of futures on broad market indices. An index is classified as a broad market index by the CFTC if the index meets the following criteria:

1. The index has 10 or more component securities;

2. No single component security comprises more than 30 percent of the index's weighting, where weighting is defined as the percentage of total market capitalization;

3. The five highest weighted component securities together comprise less than 60 percent of the index's weighting; and

4. The lowest weighted component securities comprising, in the aggregate, 25 percent of the index's weighting have an aggregate dollar value of average daily trading volume (ADTV) of $50 million or more (or in the case of an index with 15 or more component securities, $30 million or more).

If an index meets the criteria listed above, then it may be classified as a broad market index by the CFTC. The present invention is discussed in connection with meeting the criteria listed above for purposes of illustration. It will be understood that the interactive trading application may be used to create an index that meets any criteria.

As stated above, users may navigate to create/edit index screen 300 by selecting tab 203 or by pressing create button 212 or edit button 214 in screen 200 of FIG. 2.

Screen 300 includes a current index drop down menu 302 and type drop down menu 304. Current index drop down menu 302 may allow the user to select an index to edit, if so desired. Current index drop down menu 302 may default to a different setting depending on the manner in which the user navigates to screen 300. When the user accesses screen 300 by pressing create button 212 (FIG. 2) to create a new index or selects create/edit index tab 203 (FIG. 2) to visit screen 300 for the first time in an application session, current index drop down menu 302 may default to ‘new index’. When the user accesses screen 300 by pressing edit button 214 (FIG. 2) from screen 300 to edit the selected index, current index drop down menu 302 may default to the index highlighted in index window 210 (FIG. 2).

Type drop down menu 304 allows a user to select the type of index to be created. The interactive trading application will ensure that the created indices will meet the criteria (if any) associated with the type of index selected in type drop down menu 304.

Screen 300 also includes available securities window 310, industry sector filter drop down menu 316, industry sector filter button 318, market filter capitalization drop down menu 320, market filter capitalization button 322, securities-in-index window 330, add button 312, and remove button 314.

Available securities window 310 shows a list of available securities. For each available security, the interactive trading application may display in window 310 the name of the security, an abbreviated identifier, market capitalization, bid price, ask price, market price, volume weighted average price, percentage of current index, trading volume, 52 week high price and 52 week low price, various ratios (i.e. price-to-earnings and price-to-book), dividend yield, or any other suitable information. The bid price, ask price, market price, market capitalization, trading volume, price-to-earnings, price-to-book information may be updated, for example, in real-time, at periodic intervals, or when updates become available.

Industry sector drop down menu 316 and filter button 318 allow a user to filter the securities displayed in available securities window 310 by one or more industry sectors. Examples of industry sectors that can be listed in drop down menu 316 may include: banking, chemicals, energy, financial services, insurance, leisure, manufacturing, real estate, retail, telecommunications, transportation, utilities, and any other suitable industry sectors. A user may first select one or more industry sectors from drop down menu 316. When a selection has been made from industry sector drop down menu 316, a user can press filter button 318 to filter the securities displayed in available securities window 310. The original list of securities may be displayed in available securities window 310 by selecting ‘No filter’ from drop down menu 316 and pressing filter button 318.

Market capitalization drop down menu 320 and filter button 322 allow a user to filter the securities displayed in available securities window 310 by market capitalization. Examples of market capitalizations that can be listed on drop down menu 320 may include: “small-cap”, “mid-cap”, “large-cap”, less than $10 million, $10 million to $100 million, $100 million to $1 billion, $1 billion to $10 billion, $10 billion to $100 billion, and any other suitable market capitalizations. A user may first select a market capitalization from drop down menu 320. When a selection has been made from market capitalization drop down menu 320, a user can press filter button 322 to filter the securities displayed in available securities window 310. The original list of securities may be displayed in available securities window 310 by selecting ‘No filter’ from drop down menu 320 and pressing filter button 322.

The user can sort the securities in available securities window 310 according to information that is shown along with each security. For example, the user can select name header 326 to sort the securities in available securities window 310 alphabetically by name. The user can select market capitalization header 328 to sort the securities in window 310 by market capitalization. By selecting header 326 or 328 again, the order that the securities are shown may be reversed.

Securities-in-index window 330 shows the securities in the current index and a percentage of total market capitalization of the index for each security. Securities-in-index window 330 may also include the current price, market capitalization, bid price, ask price, market price, trading volume, 52 week high price and 52 week low price, various ratios (i.e. price-to-earnings and price-to-book), dividend yield, and any other suitable information. The bid price, ask price, market price, market capitalization, trading volume, price-to-earnings, price-to-book information may be updated, for example, in real-time, at periodic intervals, or when updates become available.

The user can sort the securities in securities-in-index window 330 according to information that is shown along with each security. For example, the user can select name header 340 to sort the securities listed in window 330 by name. The user can select percentage header 342 to sort the securities by percentage. By selecting header 340 or 342 again, the order that the securities are listed may be reversed.

The interactive trading application may allow the user to add or remove securities from the index by using add button 312 and remove button 314. For example, the user may add a security from available securities window 310 to securities-in-index window 330 by selecting that security and pressing add button 312. Similarly, a user may remove a security from index window 330 by selecting that security from available securities window 310 or securities-in-index window 330 and pressing remove button 314.

Screen 300 also includes guidance options button 324, update button 332, create button 334, create dialog box 336, check button 338, and guidance text box 350.

Guidance options button 324 allows the user to select the level of guidance the interactive trading application provides to assist the user in creating an index that meets the criteria. The interactive trading application may provide several levels of guidance that may include beginner, intermediate, expert, and custom. Beginner level may provide the user with the most guidance, while expert level may provide the user with the least guidance. When the user selects guidance button 324, a pop-up window may be displayed on which the user may be provided radio buttons, check boxes, or a drop down menu to make a guidance selection.

At the beginner level of guidance, the interactive trading application may, for the first step of creating a broad market index, prompt the user to enter the number of component securities that will comprise the index. The interactive trading application may then prompt the user to select component securities from available securities. When the user selects each component security, the interactive trading application may determine whether the criteria are being met and may provide assistance to the user. For example, if the user has selected six securities with large market capitalizations, the interactive trading application may remove securities with small market capitalizations from the available securities in order to ensure that the third criterion of a broad market index will be met. In this situation, the interactive trading application may alternatively take any other suitable action such as preventing the user from adding securities with small market capitalizations or informing the user that securities with small market capitalizations cannot be added because the currently selected component securities all have large market capitalizations. The interactive trading application may also suggest that the user remove any securities with small market capitalizations that have already been added to the index.

At the intermediate level of guidance, the interactive trading application may allow the user to select component securities with less guidance than in the beginner level. As securities are added to the index, the interactive trading application may display in window 310 the securities that meet the criteria in a different color, different font, or different font style such that those securities will stand out from securities that do not meet the criteria. The user may choose to add securities that do not meet the criteria. When this happens, the interactive trading application may inform the user why the criteria are not being met and provide suggestions on how the index can be changed to meet the criteria.

At the expert level of guidance, the interactive trading application may allow the user to select the component securities first before providing any feedback. After the user has selected all of the component securities, the interactive trading application may determine whether all of the criteria are met. If all of the criteria are not met, then the interactive trading application may provide suggestions to the user for how to change one or more component securities to meet the criteria.

When the user selects custom for the level of guidance, the user will be allowed to select individual guidance features that are incorporated in the fixed levels of guidance. Check boxes or radio buttons may be provided for the user to select individual features. The individual guidance features that may be selected by the user may include: hide securities that do not meet the criteria, display securities that meet the criteria and the securities that do not meet the criteria in a different manner, do not provide suggestions or guidance, always provide guidance after a security is added, prevent user from adding a security that does not meet the criteria, and any other suitable guidance features.

As shown above, the interactive trading application provides guidance when a user creates an index that meets criteria. The interactive trading application may also provide a warning to a user when some of the criteria are met by only a small amount. For example, the interactive trading application may warn a user that a created index's five highest weighted component securities in aggregate comprise 59 percent of the index's weighting and to be classified as a broad market index, the aggregate must be less than 60 percent. This warning informs the user that if the market capitalization of any of those five securities increases, the created index may no longer meet the criteria for a broad market index.

The interactive trading application may also require a margin of safety for some of the criteria. For example, the interactive trading application may require the five highest weighted component securities in aggregate to comprise less than 50 percent of the index's weighting. Therefore, small fluctuations in the share price of the component securities will not cause the created index to fail to meet the criteria for the broad market index.

Referring back to FIG. 3, check button 338 allows the user to verify that all of the criteria for an index have been met without creating or editing an index. Update button 332 allows the user to update the index displayed in menu 302 with the index containing the securities listed in securities-in-index window 330. However, if the criteria for an index have not been met, an error message will be generated. The user can enter in a name for a new index in create dialog box 336. When the user presses create button 334, the interactive trading application creates a new index with the name entered in dialog box 336. However, if the criteria for a broad market index has not been met, an error message will be generated.

Text box 350 displays messages to the user. If an error message has been generated when a user presses button 332, 334, or 338, the message may be displayed in text box 350. Similarly, all suggestions or warnings generated to guide the user may also be displayed in dialog box 350. As illustrated, text box 350 informs the user that the criteria for a broad market index is not being met because a broad market index must contain at least ten securities, whereas the current index only contains three securities. Furthermore, text box 350 informs the user that the weighting of Dell Computer is too high and may preclude the index from meeting the criteria and that the user should consider removing Dell Computer from the current index.

The interactive trading application may allow the user to request that the system provider obtain certification of the created index from a regulatory agency or agencies. For example, for a broad market index the interactive trading application may allow the user to request that the system provider obtain certification from the regulatory agency or agencies that the created index is a broad market index and thus enable regulatory approval for futures and options to be traded against that index. The interactive trading application may automatically send the created index to the regulatory agency or agencies for approval, or alternatively, the interactive trading application may require the system provider to manually submit the created index to the regulatory agency or agencies. The interactive trading application may be electronically connected to the regulatory agency or agencies via communication link 104 as shown in FIG. 1. Electronic submission of an index can take place via electronic mail, via a form on the regulatory agency or agencies website(s), via a direct connection to a regulatory agency or agencies server(s) 104 (FIG. 1), using a separate dedicated index submission application, or by any other suitable means. An index may also be submitted to the regulatory agency or agencies via postal service.

The interactive trading application also allows the user to trade a created index. In the case of a broad market index, if the CFTC approves of the created index, then futures on the created index, and options on those futures (including but not limited to binary options), may be traded on a fully margined futures exchange basis. Depending on the approval that is required and the regulatory agency or agencies, a user may be able to create and trade an index immediately or with some time delay.

In another embodiment, it may be possible to obtain approval from a regulatory agency or agencies of the interactive trading application. If the interactive trading application is approved, then any indices created using the interactive trading application would meet the criteria. This advance approval of the interactive trading application may no longer require certain advance approval requirements of each index. Therefore, this may decrease the time it would normally take to obtain approval to trade the index.

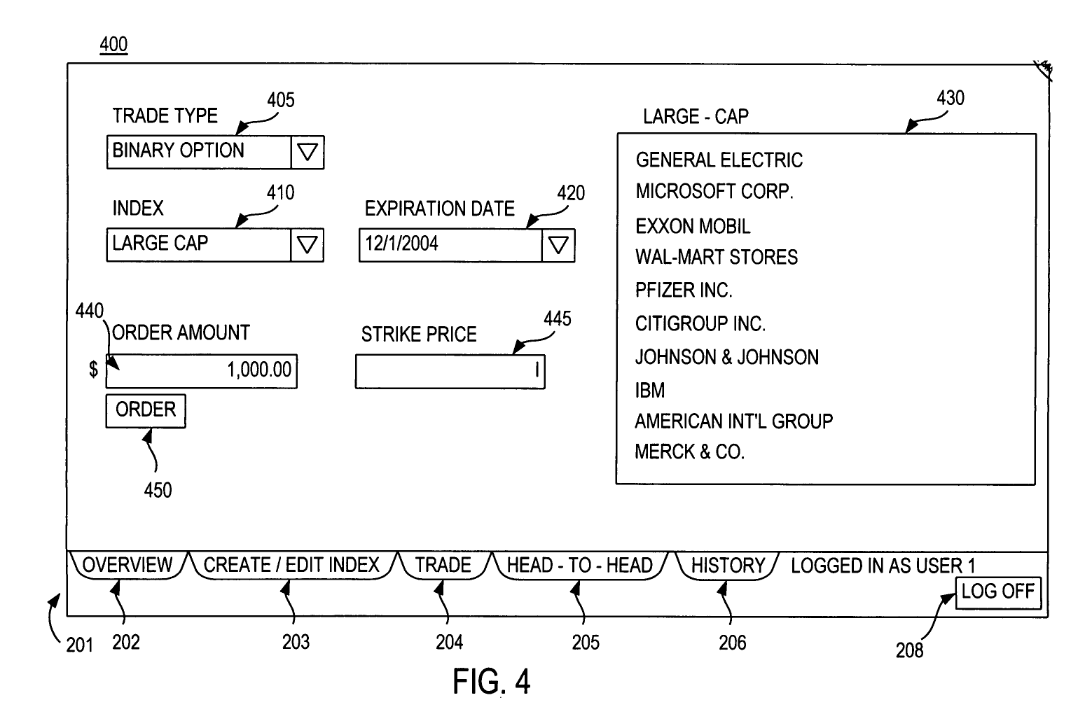

FIG. 4 shows an illustrative screen 400 in accordance with the present invention that allows a user to trade an index. Screen 400 may be accessed from any screen in the interactive trading application by selecting trade tab 204. As shown, screen 400 is configured for trading binary options. The configuration of screen 400 may differ for other types of suitable trades.

Screen 400 includes a trade type drop down menu 405, an index drop down menu 410, expiration drop down menu 420, index window 430., order amount text box 440, strike price text box 445, and order button 450. Trade type drop down menu 405 allows a user to select the type of trade to be placed. As shown, the current selected trade type is a binary, option. Screen 400 will therefore be discussed in the context of trading a binary option. Index drop down menu 410 allows the user to select a previously created index. When the user selects an index, index window 430 is updated to display the securities listed in the index. Expiration drop down menu 420 allows the user to select a date at which the binary option will expire. In another suitable approach, expiration drop down menu 420 may be a text box that allows the user to enter a date at which the option will expire. The user can enter an order amount for the binary option into text box 440. In strike price text box 445, the user can enter the strike price for the trade. The user will only receive a payout if the price of the index is higher than the strike price at the expiration date. The binary option order is placed when the user presses order button 450. The interactive trading application may require the user to confirm the order by entering a trading password. In order for a binary option order to be executed, another trader must pick up the option within a time period specified either by the user or the system. A confirmation will be sent to both traders informing them that their binary option orders have been matched and executed.

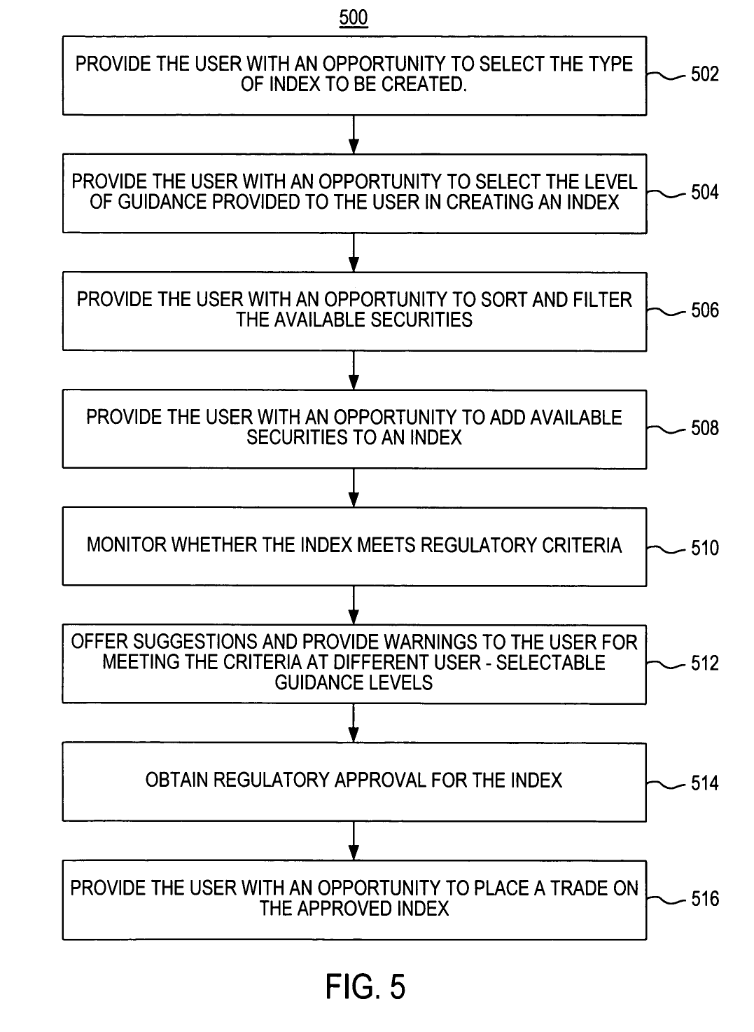

FIG. 5 shows an illustrative flow diagram of illustrative steps involved in creating and trading an index in accordance with the present invention.

At step 502, the interactive trading application may provide the user with an opportunity to select the type of index to be created. If the user selects broad market index, the interactive trading application will apply the criteria for creating a broad market index to the index being created by the user.

At step 504, the interactive trading application may provide the user with an opportunity to select the level of guidance provided to the user in creating an index. The interactive trading application may include several predefined levels of guidance such as beginner, intermediate, and expert and a custom level of guidance that the user may select to guide the user in creating an index according to the criteria associated with the type of index being created.

At step 506, the interactive trading application may provide the user with an opportunity to sort and filter the available securities. The user may be able to sort the available securities in alphabetical order, by market capitalization, or by any other suitable approach. The user may be able to filter the available securities by industry sector, market capitalization, or by any other suitable approach.

At step 508, the interactive trading application may provide the user with an opportunity to add available securities to an index.

At step 510, the interactive trading application may monitor whether the index meets regulatory criteria associated with the type of index to be created.

At step 512, the interactive trading application may offer suggestions and provide warnings to the user for meeting the criteria at different user-selectable guidance levels. If the beginner level is selected, the interactive trading application will provide the most guidance. On the other hand, if the expert level is selected, the interactive trading application will provide the least guidance. At the custom level, the user can choose the specific types of guidance that are provided. The interactive trading application may also provide warnings to the user if a criterion is only being met by a small amount.

At step 514, the interactive trading application system provider may obtain regulatory approval for the index. For example, the index may be submitted to regulatory agency server 110 (FIG. 1) either automatically or manually via communication links 104 (FIG. 1).

At step 516, the interactive trading application may provide the user with an opportunity to trade the index once it has been approved. A user, for example, may place a binary option order on a broad market index that has been created by the user and approved by the CFTC by setting a strike price, expiration date, and order amount. If at the expiration date, the price of the index exceeds the strike price, then the user will be paid the entirety of the order amount, otherwise the user will not be paid. Any other suitable trade may be placed on an approved index.

The interactive trading application also allows the user to participate in head-to-head trading with other users of the interactive trading application.

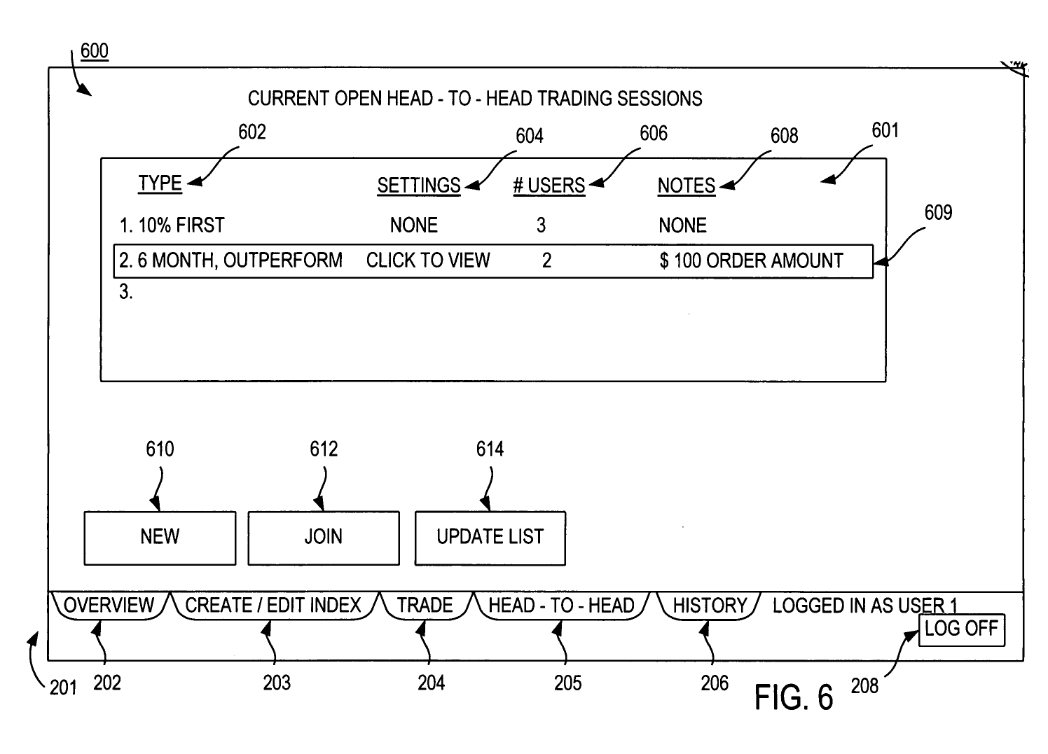

FIG. 6 shows an illustrative screen 600 in accordance with the present invention, which allows a user to create or join a head-to-head trading session. Screen 600 may be accessed from any of the screens of the interactive trading application by selecting head-to-head tab 205. Access may also be obtained into a head to head trading session via a hyperlink from a website, whereby certain preconceptions of the head to head session to be started may also be carried through from the originating website. Screen 600 includes available session area 601, new button 610, join button 612, and update button 614.

Available session area 601 shows the available head-to-head trading sessions that the user may join. Information relating to the type, settings, number of users and other notes are listed for each available head-to-head trade. The order that the sessions are listed in can be sorted by selecting type header 602, settings header 604, users header 606, and notes header 608. For example, selecting type header 602 will sort the current sessions by type, perhaps alphabetically, but more importantly, ail similar types will be grouped together. The user can select a session as shown by highlight region 609. When a session has been selected, the user may press join button 612 to join the session. Update list button 614 may allow the user to update the available head-to-head trading session list, such that sessions that are closed are no longer displayed, and new sessions that have been created are now displayed. In another suitable approach, the available head-to-head trading sessions will be updated in real-time. In another suitable approach, the sessions may remain open for all users to join until option expiry.

New button 610 allows a user to create a new head-to-head trading session. When the user presses new button 610, the interactive trading application may prompt the user to define the parameters of the head-to-head trading session.

When a user creates a new head-to-head trading session, the creating user may be asked to define the criterion for success. The criterion for success may be the security that gains 10% in value first (e.g., at closing price or intraday). In another suitable approach, the criterion for success may be the security with the greatest gain over a pre-determined period of time. The criterion for success may also be the security that outperform the other securities in relative value.

The creating user may also be prompted to restrict the securities that participating users may select to a particular set of underlying securities within a pre-defined framework. These restrictions may also be system-defined.

The user creating a new head-to-head trading session may also be prompted to define criteria for the commencement or the termination of the head-to-head trading. The interactive trading application may be configured to specify the time for the commencement or the termination of the option orders placed in a head-to-head trade. The head-to-head option period between user-defined securities may commence, for example, immediately or when one of the securities misses earnings projections. In another suitable approach, the head-to-head option period may expire only when one of the securities misses earnings projections or upon passage of a set amount of time. It should be noted that the defining event of either the commencement or termination of an option period may be any selected event or time as may be suitable for the particular event or for the particular users or participants.

The user creating a head-to-head trading session may also be prompted to define the number of users that can participate, and/or specific users that can participate in the head-to-head trading session. These restrictions may also be system-defined. Thus, a group of users may define a limited group of participants whereby the users trade only against members of their defined or chosen participants. In another embodiment of user configuration, a group of one or more users may trade against other users or cooperatively with other users. Cooperative users can place joint orders, rather than individual orders. Thus, any size group of users may be defined to allow for large head-to-head trading sessions.

The user creating the head-to-head trading session may also be asked to define minimum order amounts required of each participating user for the head-to-head trading session.

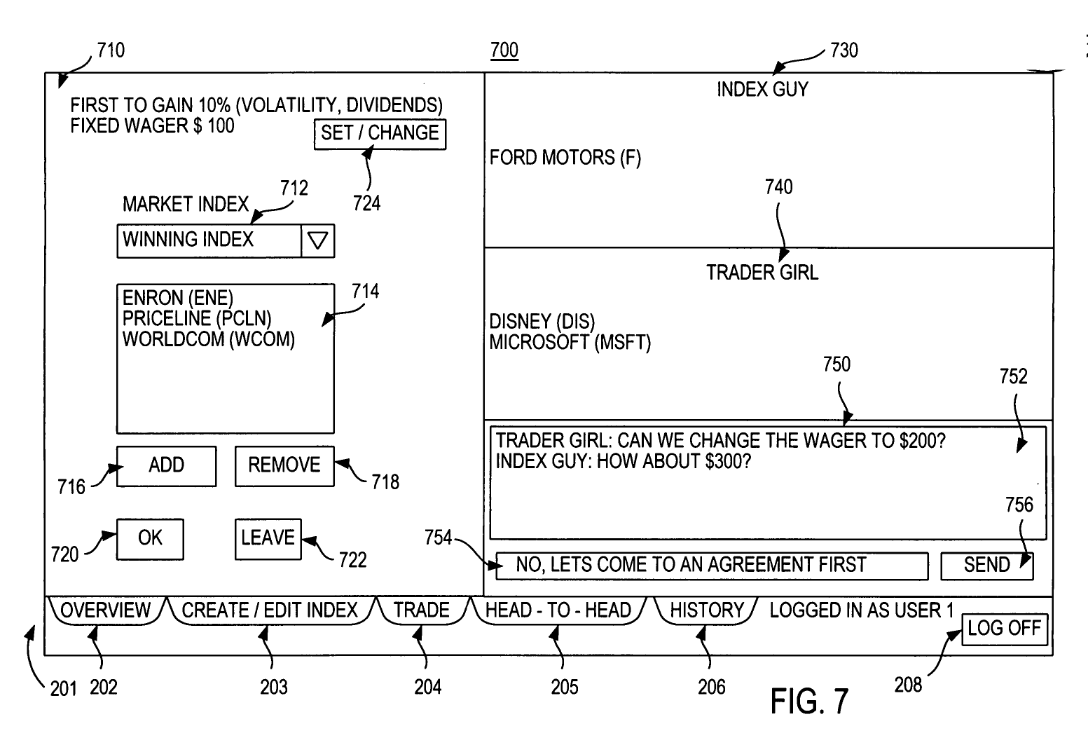

After the user creates a head-to-head trading session by pressing new button 610 and defines the parameters of the head-to-head trading session or joins a head-to-head trading session by pressing join button 612, the interactive trading application may display a screen such as screen 700 as shown in FIG. 7.

FIG. 7 shows an illustrative screen 700 in accordance with the present invention, which allows the user to select securities and to place head-to-head trades against other users. The users involved in a head-to-head trading session may need to wait until all the slots for that session have been filled, or until the creator of the session indicates that trading can begin by locking out new users.

Screen 700 is partitioned into current user area 710, other user area 730, other user area 740, and chat area 750. Current user area 710 is for the current user to enter in securities. User area 710 includes index drop down menu 712, securities Window 714, add button 716, and remove button 718. The user can select the securities in a previously created index by choosing the index from drop down menu 712. The securities listed in the selected index will be displayed in window 714. Additional securities can be added by pressing add button 716, which will prompt the user to enter an identifier (e.g. ticker symbol or CUSIP number) for that security. Selected securities can be removed by pressing remove button 718.

User area 710 also includes leave button 722. The user may leave a head-to-head trading session at any time by pressing leave button 722. If not enough users remain in a given session, the session also may not continue. However, if enough users remain in the head-to-head trading session, the session may continue.

The settings for the current session may be displayed as a reminder to users at the top of current user area 710 along with a set/change settings button 724. The creating user may be able to alter settings or criteria, preferably with the approval of the other users by pressing button 724. When the creating user presses set/change settings button 724, the interactive trading application may display a window similar to the window displayed when creating a head-to-head trade with the current settings selected. As shown, user areas 730 and 740 display the securities entered in by the two other users in the head-to-head trading session.

Chat area 750 is a general chat area, including a chat window 752, a message text box 754 and a send message button 756, where users participating in a head-to-head trade can chat. Chat window 752 lists the messages that have been sent by the other users in the order that the messages were sent, with the most recent message at the bottom. The user can enter in a message in text box 754. When the user presses send button 756, the message will be displayed in window 752 for all users to see.

Once the user is satisfied with the selected securities, the user may press ok button 720 to indicate that the user is ready to place the head-to-head order. Once all of the participating users have pressed their respective buttons 720, the users may be prompted for an order amount, if not already set. When all the order information has been entered, the users may be brought to a summary screen displaying the head-to-head trading settings, the securities involved, and the order amounts.

After each user has placed an option order against other users in the interactive trading application, the users may continue to participate in the current head-to-head trading session and place additional orders, if so desired.

In another embodiment of head-to-head trading, the head-to-head trading session may allow cooperating users to each define at least one security to trade with against another group of cooperating users. The indices for each group of cooperating users can be combined to form a virtual index on which cooperating users can place a trade.

In another embodiment of head-to-head trading, the head-to-head trading session may allow the creating user to choose a group of securities to trade with and to trade against. Other users may view the trade and decide whether or not to pick up the trade (i.e. to trade with the securities' the creating user traded against and to trade against the securities the creating user traded with).

In another embodiment of head-to-head trading, the head-to-head trading session may be presented in the form of one or more themes such as a sports theme. For example, the head-to-head trading session may allow users to select a “basketball team” of securities to place head-to-head trades. The “basketball team” may require users to select a certain number of securities that fall within various market capitalization ranges. The “basketball team” may be defined by one basketball center (a large cap stock having over two billion dollars market capitalization), two basketball forwards (mid-cap stocks of between one billion and two billion dollars market capitalization), two basketball guards (small caps of under a billion dollars market capitalization). The “basketball team” that wins would be the team that meets the criterion for success first.

Another suitable sports theme would be a horse racing theme. For example, the head-to-head trading session may allow a user to enter a horse race, where each participating user selects a single horse (any available security) on which to place an order. The prevailing horse would be the security that meets the criterion for success first.

It will be understood that the head-to-head trading session may be presented as any suitable sports theme. In addition, the theme arrangement of the head-to-head trading session may be used in any suitable fashion, or according to any suitable metric, to provide for either user-configured or system-defined constraints on head-to-head trading.

In another embodiment of head-to-head trading, instead of defining groups of securities, users may define groups of sports teams upon which to place a trade. The head-to-head trading of sports teams may be regulated by a state gaming commission or other suitable regulatory body. In this embodiment the criterion for success will be different than the criterion for success in a head-to-head trade involving securities. A few examples of criteria for success include, but are not limited to: most number of wins, most points scored, or any other suitable criteria, or combination of such criteria.

In another embodiment of head-to-head trading, users may define groups of sports players upon which to place a trade. The head-to-head trading of sports players may be regulated by a state gaming commission or other suitable regulatory body. In this embodiment, the criterion for success will be different than the criterion for success in a head-to-head trade involving securities. A few examples of criteria for success include: most number of wins, most points scored, most number of strikeouts, most number of homeruns hit, or any other suitable criteria, or combination of such criteria. In another suitable approach, each user of the interactive trading application may be able to earn points based on the performance of the group of players defined by the user. For example, a user may be awarded two points for every strikeout earned by a pitcher selected by the user or one hundred points for every major golf tournament won by a golfer selected by the user. The criterion for success may be the user with the most points. In this approach, the users of the interactive trading application may be able to define a group of sports players of various types because success of a trade is based on points rather a specific statistic, such as number of baskets scored.

The interactive trading application may present the user with a trading history window when the user selects history tab 206. The history window (not shown) may include information relevant to each order placed by the user and its current status. The orders may be listed by expiration date, index or security traded, order value, date traded, or by any other suitable means. Each order may be accompanied by relevant information such as, type of trade, current price of a security or index, securities or index traded, trading date, other parties involved in the trade, trade amount, whether or not the option is in the money, strike price, or any other suitable information.

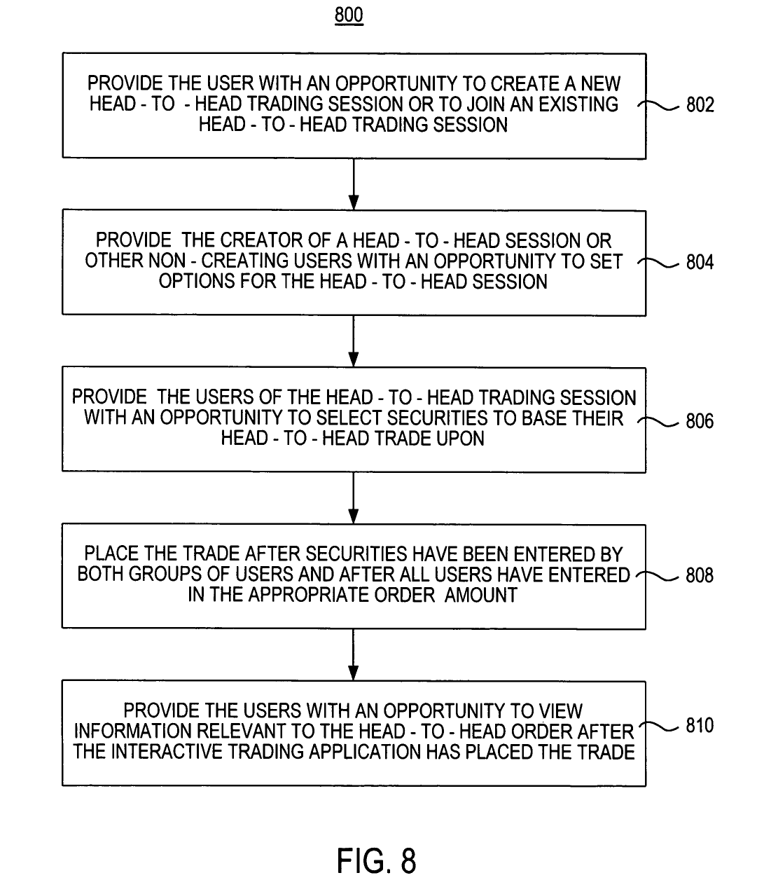

FIG. 8 shows an illustrative flow diagram of illustrative steps involved in performing head-to-head trading in accordance with the present invention.

At step 802, the interactive trading application may provide the user with an opportunity to create a new head-to-head trading session or to join an existing head-to-head trading session.

At step 804, the interactive trading application may provide the creator of a head-to-head session, or other non-creating users, with an opportunity to set options for the head-to-head session. The options may include for example, criterion for success, user criteria, restrictions on securities, order amounts, commencement and termination dates, and any other suitable trading options. Cooperating users may agree to place orders of different values, as long as the sum of the order values between a group of cooperating users equals the required order amount for the group.

At step 806, the interactive trading application may provide the users of the head-to-head trading session with an opportunity to select securities to base their head-to-head trade upon.

At step 808, the interactive trading application may place the trade after securities have been entered by both groups of users and after all users have entered in the appropriate order amount.

At step 810, the interactive trading application may provide the users with an opportunity to view information relevant to the head-to-head order after the interactive trading application has placed the trade.

The interactive trading application may also allow for the adjustment of the criterion for success of an option trade according to initial market factors or intervening significant events. The trade may be a head-to-head trade or any other suitable trade.

When the user is creating an option order, the interactive trading application may allow the user to adjust the criterion for success to account for a greater or lesser likelihood of success based on initial market factors, such as volatility. For example, if the criterion for success in a head-to-head trade is the first stock to gain 10% and two different stocks are selected, a high volatility stock will be more likely to prevail over a low volatility stock. Therefore, the criteria for success of the low volatility stock can be adjusted downwards from 10% such that the probability of the low volatility stock of reaching the adjusted price is substantially equal to the probability of the high volatility stock gaining 10% at the time the trade is placed.

Intervening significant events that occur during the option period may also be a factor for adjusting the criterion for success of a trade. A payment of dividend may be an intervening significant event. For example, if a binary option order is placed on a stock, payment of a dividend during the trade period may lower the strike price by the amount of the per share price of the dividend paid.

An intervening significant event may also be an event of corporate significance. Such events of corporate significance may include: an increase of dividend, the buyback of stock, conception of a new company, divestitures, acquisitions, and any other suitable events.

Another intervening significant event may be the release of industry relevant data. For example, the release of revenue per passenger mile data may be an important event upon which the criterion for success of an airline stock may be adjusted.

Other intervening significant events may be global market events including: war, political turmoil, terrorism, outbreak of disease, natural disasters, and any other suitable global market events.

These intervening significant events are quantified and factored out of the price of the securities in order to provide an objective comparison of the companies underlying the securities.

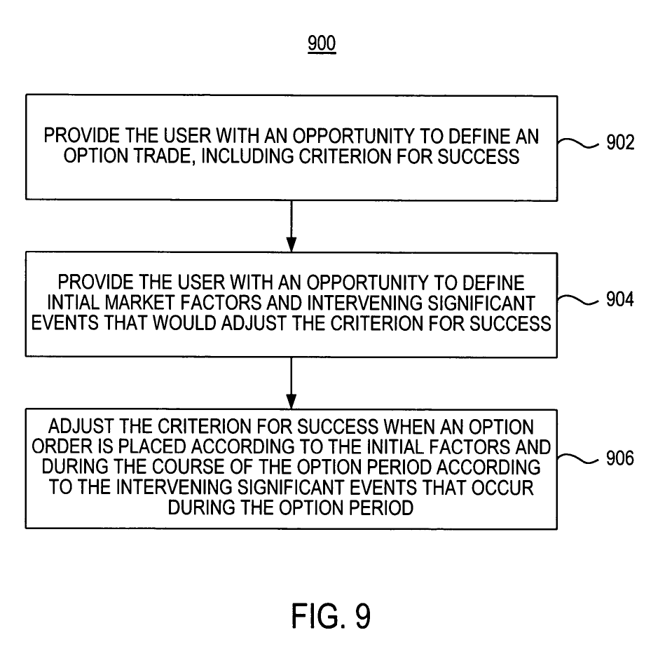

FIG. 9 shows an illustration of a flow diagram of illustrative steps involved in adjusting the criterion for success in a trade in accordance with the present invention.

At step 902, the interactive trading application may provide the user with an opportunity to define an option trade, including criterion for success.

At step 904, the interactive trading application may provide the user with an opportunity to define initial market factors and intervening significant events that would adjust the criterion for success.

At step 906, the interactive trading application may adjust the criterion for success when an option order is placed according to the initial factors and during the course of the option period according to intervening significant events that occur during the option period.

In another embodiment, the required order amounts for a trade can be adjusted instead of the criterion for success. The above-mentioned initial factors and intervening significant events that occur during the option period may affect the payment amount to the prevailing trader. The prevailing trader may be paid more or less than the sum of the order amounts if the prevailing trade had a smaller likelihood of prevailing or a larger likelihood of prevailing, respectively. Similarly, the losing trader may have to pay more or get refunded for a portion of the order amount if the prevailing trade had a smaller likelihood of prevailing or a larger likelihood of prevailing, respectively.

Accordingly, systems and methods for creating and trading indices, performing head-to-head trading, and adjusting the criterion for success of a trade are provided. It will be understood that the foregoing is merely illustrative of the principles of the invention and that various modifications can be made by those skilled in the art without departing from the scope and spirit of the invention, which is limited only be the claims that follow.

What is claimed is:

1. A method for using an interactive trading application to create an index that meets criteria comprising:
providing a user with an opportunity to select a plurality of component securities;
adding each of the selected component securities to the index;
determining whether the index meets the criteria; and
providing guidance to the user in order to ensure that the index meets the criteria.

2. The method defined in claim 1 wherein the criteria are the criteria for a broad market index.

3. The method defined in claim 2 wherein the criteria for a broad market index comprises:
the index has ten or more securities, wherein the percentage of total market capitalization is defined as a weighting for each security;
no single component security comprises more than thirty percent of the index's weighting;
the five highest weighted securities together comprise less than sixty percent of the index's weighting; and
the lowest weighted component securities that in aggregate comprise twenty-five percent of the index's weighting have an average daily trading volume of $50 million or more, or $30 million or more if the index contains more than 15 component securities.

4. The method defined in claim 1 further comprising obtaining regulatory approval for the created index.

5. The method defined in claim 4 wherein regulatory approval is obtained from the Commodity Futures Trading Commission.

6. The method defined in claim 1 further comprising:
displaying a list of available securities from which the user is allowed to select the plurality of component securities; and
providing the user with an opportunity to filter the list of available securities by industry sector and market capitalization.

7. The method defined in claim 1 wherein providing guidance further comprises prompting the user to specify the total number of component securities that are to be added to the index.

8. The method defined in claim 1 wherein providing guidance further comprises preventing the user from adding securities that will cause the index to be in violation of the criteria.

9. The method defined in claim 1 wherein providing guidance further comprises providing suggestions to the user for how to change one or more component securities to bring the index in compliance with the criteria.

10. The method defined in claim 1 wherein providing guidance further comprises warning the user when the criteria are met by only a small amount.

11. The method defined in claim 1 wherein providing guidance further comprises requiring an index to meet at least one aspect of the criteria by a margin of safety.

12. The method defined in claim 1 further comprising obtaining regulatory approval for the interactive trading application, wherein all indices created by the interactive trading application are automatically approved.

13. The method defined in claim 1 further comprising allowing the user to trade on the approved index.

14. The method defined in claim 13 wherein the trade is a binary option.

15. A method for head-to-head trading of securities between two or more users comprising:
providing a first user with an opportunity to create a head-to-head trading session;
providing a second user with an opportunity to join the head-to-head trading session;
providing the first user or the second user with an opportunity to define a criterion for success;
providing the first user with an opportunity to select a security;
providing the second user with an opportunity to select a security; and
providing the first user and the second user with an opportunity to place an option trade against each other based on the performance of the security selected by the first user and the security selected by the second user, whereon the criterion of success determines which user receives the payout of the option trade.

16. The method defined in claim 15 wherein the criterion for success is the first security to gain a predetermined percentage.

17. The method defined in claim 15 wherein the option trade includes an option period and wherein the criterion for success is the security to gain the greatest amount during the option period.

18. The method defined in claim 15 further comprising allowing the first user to restrict the securities the second user may select to a particular group of securities.

19. The method defined in claim 18 wherein the particular group of securities is restricted to securities that fall within a market capitalization range.

20. The method defined in claim 15 wherein the option trade includes an option period, the method further comprising allowing the creating user to define an event to commence the option period.

21. The method defined in claim 20 wherein the commencement event is when one of the securities misses earnings projections.

22. The method defined in claim 15 wherein the option trade includes an option period, the method further comprising allowing the creating user to define an event to terminate the option period.

23. The method defined in claim 22 wherein the termination event is when one of the securities misses earnings projections.

24. The method defined in claim 22 wherein the termination event is the passage of a pre-determined amount of time from commencement of the option period.

25. The method defined in claim 15 further comprising allowing the first user to specify the total number of users that are allowed to join the head-to-head trading session.

26. The method defined in claim 15 further comprising providing the first user with an opportunity to select specific users that can join the head-to-head trading session.

27. The method defined in claim 15 further comprising providing the first and the second users with an opportunity to select two or more securities for the option trade.

28. The method defined in claim 15 further comprising providing the first and second users with an opportunity to select an index for the option trade.

29. A method for adjusting a criterion for success of an option trade comprising:
providing a user with an opportunity to define an option trade including the criterion for success and an option period;
providing the user with an opportunity to determine at least one intervening significant event for adjusting the criterion for success; and
adjusting the criterion for success during the option period according to the occurrence of at least one intervening significant event.

30. The method defined in claim 29 wherein one intervening significant event for adjusting the criterion for success is the payment of a scheduled dividend during the option period.

31. The method defined in claim 29 wherein one intervening significant event for adjusting the criterion for success is the payment of a non-scheduled dividend during the option period.

32. The method defined in claim 29 wherein one intervening significant event for adjusting the criterion for success is an event of corporate significance occurring during the option period.

33. The method defined in claim 32 wherein the event of corporate significance is an increase in the payment of a dividend.

34. The method defined in claim 32 wherein the event of corporate significance is a buyback of stock.

35. The method defined in claim 32 wherein the event of corporate significance is a conception of a new company.

36. The method defined in claim 32 wherein the event of corporate significance is a divestiture.

37. The method defined in claim 32 wherein the event of corporate significance is an acquisition.

38. The method defined in claim 29 wherein one intervening significant event is release of industry-relevant data.

39. The method defined in claim 29 wherein one intervening significant event is a global market event.

40. The method defined in claim 29 wherein the trade is a head-to-head trade.

41. The method defined in claim 29 wherein the trade is a binary option.

42. The method defined in claim 29 further comprising providing the user with an opportunity to determine at least one initial market factor for adjusting the criterion for success.

43. The method defined in claim 42 wherein the initial factor for adjusting the criterion for success is volatility.

44. An interactive trading system on which an interactive trading application is implemented for creating an index that meets criteria comprising:
user equipment configured to:
provide a user with an opportunity to select a plurality of component securities;
add each of the selected component securities to the index;
determine whether the index meets the criteria; and
provide guidance to the user in order to ensure that the index meets the criteria.

45. The system defined in claim 44 wherein the criteria are the criteria for a broad market index.

46. The system defined in claim 45 wherein the criteria for the broad market index comprises:
the index has ten or more securities, wherein the percentage of total market capitalization is defined as a weighting for each security;
no single component security comprises more than thirty percent of the index's weighting;
the five highest weighted securities together comprise less than sixty percent of the index's weighting; and
the lowest weighted component securities that in aggregate comprise twenty-five percent of the index's weighting have an average daily trading volume of $50 million or more, or $30 million or more if the index contains more than 15 component securities.

47. The system defined in claim 44 further comprising a regulatory agency server, wherein the user equipment is coupled the regulatory agency server and wherein the user equipment is configured to obtain regulatory approval for the created index by transmitting information regarding the created index to the regulatory agency server.

48. The system defined in claim 47 wherein the regulatory agency server is operated by the Commodity Futures Trading Commission.

49. The system defined in claim 44 wherein the user equipment is further configured to:
display a list of available securities from which the user is allowed to select the plurality of component securities; and
provide the user with an opportunity to filter the list of available securities by industry sector and market capitalization.

50. The system defined in claim 44 wherein the guidance comprises prompting the user to specify the total number of component securities that are to be added to the index.

51. The system defined in claim 44 wherein the guidance comprises preventing the user from adding securities that will cause the index to be in violation of the criteria.

52. The system defined in claim 44 wherein the guidance further comprises providing suggestions to the user for how to change one or more component securities to bring the index in compliance with the criteria.

53. The system defined in claim 44 wherein the guidance comprises warning the user when the criteria are met by only a small amount.

54. The system defined in claim 44 wherein the guidance comprises requiring an index to meet at least one aspect of the criteria by a margin of safety.

55. The system defined in claim 44 further comprising a regulatory agency server, wherein the interactive trading system is coupled to the regulatory agency server, wherein the interactive trading system is configured to obtain regulatory approval from the regulatory agency server for the interactive trading application by transmitting at least a portion of the interactive trading application to the regulatory agency server, and wherein all indices created by the interactive trading application are automatically approved.

56. The system defined in claim 44 wherein the user equipment if further configured to allow the user to trade on the approved index.

57. The system defined in claim 56 wherein the trade is a binary option.

58. An interactive trading system for head-to-head trading of securities between two or more users comprising:
first user equipment configured to:
provide a first user with an opportunity to create a head-to-head trading session;
provide the first user with an opportunity to define a criterion for success;
provide the first user with an opportunity to select a security; and
provide the first user with an opportunity to place an option trade against a second user;
second user equipment configured to:
provide the second user with an opportunity to join the head-to-head trading session;
provide the second user with an opportunity to select a security; and
provide the second user with an opportunity to place an option trade against the first user; wherein the option trade is based on the performance of the security selected by the first user and the security selected by the second user and whereon the criterion of success determines which user receives the payout of the option trade; and
a computer network configured to couple the first user equipment with the second user equipment.

59. The system defined in claim 58 wherein the criterion for success is the first security to gain a predetermined percentage.

60. The system defined in claim 58 wherein the option trade includes an option period and wherein the criterion for success is the security to gain the greatest amount during the option period.

61. The system defined in claim 58 wherein the first user equipment is further configured to allow the first user to restrict the securities the second user may select to a particular group of securities.

62. The system defined in claim 61 wherein the particular group of securities is restricted to securities that fall within a market capitalization range.

63. The system defined in claim 58 wherein the option trade includes an option period and wherein the first user equipment is further configured to allow the first user to define an event to commence the option period.

64. The system defined in claim 63 wherein the commencement event is when one of the securities misses earnings projections.

65. The system defined in claim 58 wherein the option trade includes an option period and wherein the first user equipment is further configured to allow the first user to define an event to terminate the option period.

66. The system defined in claim 65 wherein the termination event is when one of the securities misses earnings projections.

67. The system defined in claim 65 wherein the termination event is the passage of a pre-determined amount of time from commencement of the option period.

68. The system defined in claim 58 wherein the first user equipment is further configured to allow the first user to specify the total number of users that are allowed to join the head-to-head trading session.

69. The system defined in claim 58 wherein the first user equipment configured to provide the first user with an opportunity to select specific users that can join the head-to-head trading session.

70. The system defined in claim 58 wherein the first user equipment is further configured to provide the first user with an opportunity to select two or more securities for the option trade and wherein the second user equipment is further configured to provide the second user with an opportunity to select two or more securities for the option trade.

71. The system defined in claim 58 wherein the comprising first user equipment is further configured to provide the first user with an opportunity to select an index for the option trade and wherein the second user equipment is further configured to provide the second user with an opportunity to select an index for the option trade.

72. An interactive trading system for adjusting a criterion for success of an option trade, the system being configured to:
provide a user with an opportunity to define an option trade including the criterion for success and an option period;
provide the user with an opportunity to determine at least one intervening significant event for adjusting the criterion for success; and
adjust the criterion for success during the option period according to the occurrence of at least one intervening significant event.

73. The system defined in claim 72 wherein one intervening significant event for adjusting the criterion for success is the payment of a scheduled dividend during the option period.

74. The system defined in claim 72 wherein one intervening significant event for adjusting the criterion for success is the payment of a non-scheduled dividend during the option period.

75. The system defined in claim 72 wherein one intervening significant event for adjusting the criterion for success is an event of corporate significance occurring during the option period.

76. The system defined in claim 75 wherein the event of corporate significance is an increase in the payment of dividend.

77. The system defined in claim 75 wherein the event of corporate significance is a buyback of stock.

78. The system defined in claim 75 wherein the event of corporate significance is a conception of a new company.

79. The system defined in claim 75 wherein the event of corporate significance is a divestiture.

80. The system defined in claim 75 wherein the event of corporate significance is an acquisition.

81. The system defined in claim 72 wherein one intervening significant event is release of industry-relevant data.

82. The system defined in claim 72 wherein one intervening significant event is a global market event.

83. The system defined in claim 72 wherein the trade is a head-to-head trade.

84. The system defined in claim 72 wherein the trade is a binary option.

85. The system defined in claim 72, wherein the interactive trading system is further configured to provide the user with an opportunity to determine at least one initial market factor for adjusting the criterion for success.

86. The system defined in claim 85 wherein one initial market factor for adjusting the criterion for success is volatility.
